(19) United States
(12) Patent Application Publication
(10) Pub. No.: US 2012/0058295 A1
(43) Pub. Date: Mar. 8, 2012

(54) ADHESIVE FASTENING PART

(76) Inventor: Konstantinos Poulakis, Hildrizhausen (DE)

(21) Appl. No.: 13/261,012

(22) PCT Filed: Jun. 15, 2010
(86) PCT No.: PCT/EP2010/003569

§ 371 Date: Nov. 15, 2011

(30) Foreign Application Priority Data
Jul. 9, 2009 (DE) 10 2009 032 301.5

(51) Int. Cl. B32B 33/00

(52) U.S. Cl. 428/91

(57) ABSTRACT

An adhesive fastening part, with a flat carrier part (14) made from warp (10) and weft threads (12) and with closure elements (18) which project from the carrier part (14) and are formed from loop piles (16) which are anchored on the carrier part (14), is characterized in that, for the free adaptation of the reflection properties of the adhesive fastening part to the corresponding reflection properties of a functional structure, in particular a clothing fabric, which carries the adhesive fastening part, at least parts of the fastening part, preferably weft threads (12), are formed from a thread material which has a preselected reflectivity with respect to infrared radiation.

The invention relates to an adhesive fastening part with a planar backing part made of warp and weft threads and with fastener elements which project from the backing part and are formed by pile threads that are anchored on the backing part.

Such touch-and-close fastener parts, which are produced in weaving technology and have warp, weft, and pile threads made of textile fibers or also of synthetic fibers, are readily available on the market in a plurality of embodiments. One example of such a touch-and-close fastener part is described in document DE 102 40 986 B3. In this case, the pile threads form fastener elements in the form of loop-shaped interlocking elements. If the closed loops of the pile threads are cut open or separated from each other by thermal means, then the fastener elements form a type of fastener hook that can be brought into engagement with a correspondingly configured fleece loop material of another fastener part. If, in the separating process, the free loop ends of the pile threads made of a synthetic plastic material are heat-treated—for example, fused—then mushroom-shaped fastener heads are obtained as the fastener elements owing to the inherent behavior of the synthetic plastic material.

Good peel strength values can be obtained with such prior art touch-and-close fastener systems, so that reliable connections of the respective performance structures can be achieved. Owing to this advantageous behavior and the possibility of cost-effective fabrication, such fastener systems have become very popular and are also used, in particular, as detachable fasteners in articles of clothing. Owing to the necessary good peel strength values, such fastener systems are also used advantageously in articles of clothing that are provided for conditions of rugged use—for example, protective clothing and parts of uniforms. If the latter clothing is intended for police or military use, then the respective articles of clothing must meet special requirements in conformity with the current development of safety and defense technology. For example, in order to provide the wearer of a respective article of performance clothing, in particular safety clothing or a part of a uniform, optimal safety against target detection by infrared aiming devices or night vision devices, the surface of the respective article of clothing that is exposed to the infrared ray has to exhibit such a reflectance behavior in relation to the infrared radiation that the obtained infrared image is as weak as possible, lacks contrast, and is without pronounced contours. In order to achieve this goal with respect to such high performance clothing, it is customary to select clothing materials exhibiting a reflectance behavior that yields an infrared image that is as “poor” as possible, that is, has poor contrast and is as free of contours as possible. However, this demand is confronted with the difficulty that touch-and-close fastener parts that are found on performance clothing may appear as contours or contrast areas in the infrared image. For this reason, it is customary to dye the touch-and-close fastener parts in the finished state or, in the case of touch-and-close fastener parts that are made of warp, weft, and pile threads, to dye the yarns of the woven fabric.

This solution is not satisfactory, if such high performance clothing, especially if said clothing is used for rough applications with the risk of soiling, has to be cleaned relatively often. Therefore, after a relatively short period of use, the dye that is used for the coloration is usually washed or bleached out, so that the contrast area and/or the contours are visible again in the thermal image.

In light of this problem, the object of the invention is to provide a touch-and-close fastener part of the type under consideration and which is distinguished by an improved performance behavior, in particular, during long term use.

The invention solves this problem with a touch-and-close fastener part having the features specified in claim 1 in its entirety.

Working on this basis, an important particularity of the invention resides in the fact that in order to adapt the reflectance behavior of the touch-and-close fastener part to the respective reflectance behavior of the performance structure—that is, in particular, the respective clothing material—at least parts of the fastener part—preferably the weft threads—are made of a thread material that exhibits a preselected reflectivity with respect to the infrared radiation. In contrast to dyeing the entire fastener part or dyeing the threads that form the fabric of the backing part and the pile threads, the invention uses components of the fabric that offer on their own—that is, without the applied coloration—the respective suitable reflectance behavior. This feature eliminates the risk of the dye being washed out during the washing or cleaning processes and, as a result, destroying the safety effect.

Preferably, filaments made of a material of a selected color are provided as the parts of the preselected reflectivity. In this case, it is possible to consider, for example, gray, dark, or black threads that yield, alone or in combination with the other threads of the fabric, a reflectivity that is adapted to the reflectivity of a performance structure—in particular, clothing material—that is adjacent to the touch-and-close fastener part.

Woven touch-and-close fastener parts are often made of thread materials made of a synthetic plastic material. In the case of such touch-and-close fastener parts, it is possible to provide the filaments made of a synthetic plastic material exhibiting the selected color as the parts of the preselected reflectivity. Hence, it is possible to use carbon threads or threads in which pigments are incorporated into the polymer compound prior to being extruded from the spinnerets. In any event, the invention provides threads that are dyed in the compound, that is, do not have a color-coating that could be abraded or washed off during use.

In this context, the arrangement can be configured in such a way that the filaments that have the selected color are provided as the monofilament or form a part of a multifilament.

In especially advantageous embodiments, the weft threads can be formed by a monofilament made of a yarn exhibiting the selected color.

However, the arrangement may also be configured so that the weft threads are formed by multifilaments of yarns, of which at least one has the selected color.

With respect to the pile threads, the arrangement can be configured in such a way that said pile threads are formed by a multifilament made of yarns of varying diameter, of which at least one yarn exhibits the selected color.

The pile threads can be anchored to the backing part in an advantageous way so that the pile threads are integrated into the backing part as a V-weave or W-weave.

In the event that the performance structure, for example, the clothing material, exhibits suitable properties, it is also possible to form all of the filaments of the warp, well, and/or pile threads from filaments having the selected color.

The invention is explained in detail below with reference to the drawings.

FIG. 1 is a schematic drawing, not drawn to scale, showing the fabric of an exemplary embodiment of the inventive touch-and-close fastener part in a top plan view;

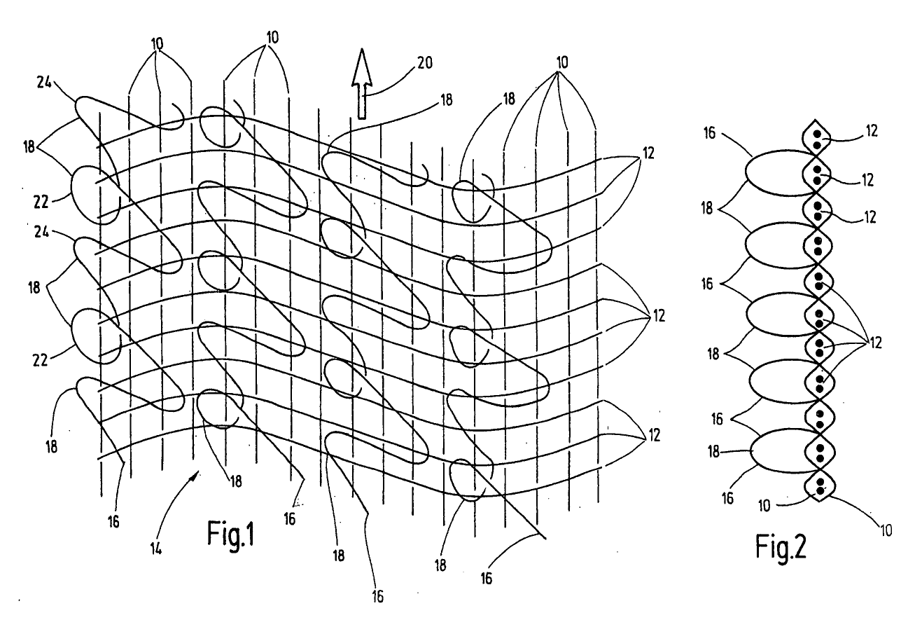

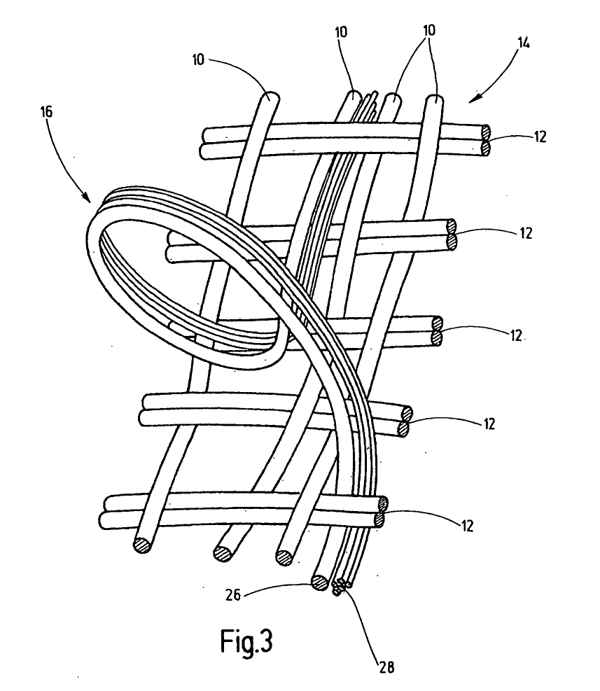

FIG. 2 is a side view of the planar touch-and-close fastener part of FIG. 1, and

FIG. 3 is an exploded detail showing an exemplary embodiment of the touch-and-close fastener part in a perspective oblique view.

FIG. 1 is a top plan view of a section of the planar touch-and-close fastener part according to the invention. This touch-and-close fastener part may be extended, as desired, inside the plane of the drawing in both the one and also the other direction of the illustration; and the geometric dimensions of the planar formation depend on the settings of the weaving device in which the touch-and-close fastener part is produced. The touch-and-close fastener part is made of warp threads 10 and weft threads 12 that are interwoven in a transverse configuration to form the base fabric of the backing part 14 for the fastener elements 18 of the touch-and-close fastener part. Furthermore, the backing part 14 is also formed from the pile threads 16 that are used to form the individual fastener elements 18. Then the respective pile thread 16 forms, as discussed below, the individual fastener elements 18.

Furthermore, when seen in the line of sight to FIG. 1, the upper side has an arrow 20 that indicates the direction of production for the touch-and-close fastener part. In the configuration depicted in FIG. 1, the respective weft threads 12 are configured so as to curve in the manner of a sine wave. At the points of intersection between the warp threads and the well threads, the warp threads 10 run parallel to the direction of production 20 and parallel to each other in a linear configuration. In the embodiments (not illustrated) of the touch-and-close fastener part according to the invention, it would also be possible to configure the warp threads 10, in addition or as an alternative, so as to curve in the manner of a sine wave. In order to ensure that the weft threads 12 follow a curved path as shown in the drawing in FIG. 1, the producing loom (not shown) provided for this purpose has a suitably wave-shaped reed insert in the form of the sine wave required. Consequently, the touch-and-close fastener according to the invention may be provided in large quantities at a high rate of production. The sinusoidal reed (not shown) engages with the respective base fabric of the backing part 14 transversely to the direction of production 20 to produce the curved weft thread pattern. In the embodiment according to FIG. 1, the respective pile thread 16 extends at least partially between two adjacent warp threads 10 in the backing part 14. In the configuration depicted in FIG. 1, they extend in sequence below every fourth weft thread 12 and above the other weft threads 12. At the site of the respective extension under the backing part 14, the pile thread 16 forms a superposed loop 22. Another loop is formed immediately after it, so that a type of V-shaped weave is produced. However, other types of weaves are also conceivable, for example, integrating the pile thread 16 in a W-shaped form or the like.

The said loops 22, 24 form the fastener elements 18. If the loops remain closed, as illustrated, then the result is a type of fleece touch-and-close fastener part, wherein hook-like or mushroom-like fastener elements can engage with the loops 22, 24, in order to obtain in this way a detachable touch-and-close fastener. On the other hand, there is the possibility of cutting the loops 22, 24 open, so that then the result is a fastener hook that may engage with the corresponding nonwoven or fleece material of another fastener part that is not shown. If the separation or cutting process is carried out by thermal means, and in particular, the temperature of the free loop ends is increased even more, then the ends shrink together and, in so doing, form mushroom-like fastener heads, so that the fastener hooks may also be mushroom-shaped (not shown). It is also possible to produce combined fasteners—that is, ones with hook-shaped and loop-shaped elements—on a common backing part 14.

As shown, in particular, in the drawing according to FIG. 2, an individual weft thread 12 may consist of a pair of weft threads or be in the form of multiple threads. This also applies to the warp threads 10 which extend, according to the cross-sectional view in FIG. 2, in alternating sequence above a pair of weft threads 12 and then below this pair of weft threads 12. At the same time, the respective pile thread 16 misses one pair of weft threads 12 and then extends over the two following pairs of weft threads 12 in the sequence shown. It is also apparent from the two drawings 1 and 2 that in order to extend below the base fabric 14, the respective other loop 24 extends below a weft thread 12 which is offset, when seen in the line of sight to FIG. 1, by two warp threads 10 and two weft threads 12 laterally from the point at which the preceding loop 22 has its position on the backing part 14. Consequently, the loops of the first type 22 and of the other type 24 are arranged on the backing part 14 so as to be offset from each other, the loops of the first type 22 forming in essence closed O-shaped loops, and the loops of the other type 24 are configured to be V-shaped or U-shaped. A so-called repeat is effected for a pile thread 16 in the direction of the weft threads 12 after five warp threads 10. In addition, the thread systems may consist of textile fibers, but preferably they are made of a synthetic plastic material—in particular, nylon or polypropylene material, polyester, or polyamide—materials that are provided with suitable pigments prior to issuing from the spinnerets in order to obtain the selected color, so that the desired and adapted reflectance behavior of the fabric made with the threads is obtained. If the threads of an especially dark color or black threads are under consideration, then carbon threads can form parts of the fabric, for example, the weft threads. For such touch-and-close fastener parts, a weft density of, for example, 14 to 17 picks/cm can be provided.

Owing to the wave-shaped configuration (shown in FIG. 1) of the weft threads 12, it is possible to achieve a higher resistance in the direction of peeling in the event of a peeling process and, moreover, upon release of the fastener by the correspondingly offset configuration of the loops 22, 24, a feature that favors the fastener force behavior and, thus, results in high fastening and peel strength values for the fastener.

It is also clear from FIG. 3 that at least a part of the threads that are used for the backing part 14 and/or the fastener elements (pile threads 16) may consist of a yarn system that is formed in the sense of a two-component system of at least two related and adjacent yarns of different types. In the example of FIG. 3, the warp threads 10 are made, as in the example of FIGS. 1 and 2, of monofilaments, wherein the weft threads 12 consist of a pair of weft threads in the form of multifilaments arranged in pairs.

The pile threads 16 according to FIG. 3 are constructed as a two-component system and exhibit accordingly a first type of yarn 26 and a second type of yarn 28. The one yarn of the yarn type 26 is constructed as a so-called monofilament thread; and the combined yarns of the other second yarn type 28 form multifilament threads that extend parallel to each other. For example, the yarn diameter of the multifilament yarn of the first yarn type 26 may be approximately 0.03 mm in diameter; and all yarns of the other yarn type 28 are significantly smaller than 0.03 mm in diameter. For example, ten multifilament yarns of the other yarn type 28 may be in total smaller than or equal to 0.03 mm in diameter. For the sake of a better understanding of the drawing, not all of the yarns of the multifilament configuration according to the other yarn type 28 were shown, but rather the drawing according to FIG. 3 shows only five by way of example.

The result of the selected two-component configuration for the yarn system forming the pile threads 16 is a type of symbiosis for its individual yarns, because the multiple yarns of the second yarn type 28 may be supported on the individual yarn of the first yarn type 26 and, as a result, can keep their position as the projecting engagement or fastener element, even if, when seen in the line of sight to FIG. 3, a bearing force is applied from the top, for example, due to bringing closer together an additional corresponding fastener part with projecting hook elements (not shown). On the other hand, the probability that the individual yarn of the yarn type 26 can be used is higher, due to the multiple configuration for a hook to extend under a corresponding fastener part.

The choice of color of the thread material of the individual components of the fabric, in particular the weft threads 12, allows the reflectance behavior of the entire fabric—that is, the entire touch-and-close fastener part which is exposed to an incoming infrared radiation—to be adapted to the respective reflectance behavior of the performance structure which is adjacent to the touch-and-close fastener part, in relation to the same type of radiation (infrared radiation) in such a way that the touch-and-close fastener part does not stand out against the surrounding performance structure in the reflected image (thermal image), so that the camouflaging effect of the performance structure—that is, for example, the uniform part—is not adversely affected by the touch-and-close fastener part that is located thereon.

1. An adhesive fastening part with a planar backing part (14) made of warp (10) and weft threads (12) and with fastener elements (18) which project from the backing part (14) and are formed by pile threads (16) that are anchored on the backing part (14), characterized in that in order to freely adapt the reflectance behavior of the adhesive fastening part to the respective reflectance behavior of a performance structure, in particular, a clothing material that bears the touch-and-close fastener part, at least parts of the fastener part, preferably the weft threads (12), are made of a thread material that exhibits a preselected reflectivity with respect to infrared radiation.

2. The touch-and-close fastener part according to claim 1, characterized in that filaments (10, 12, 16) made of a material having a selected color are provided as the parts of the preselected reflectivity.

3. The touch-and-close fastener part according to claim 2, characterized in that filaments (10, 12, 26) made of a synthetic plastic material having the selected color are provided.

4. The touch-and-close fastener part according to claim 1, characterized in that the backing part (14) and the pile threads (16) exhibit monofilaments and/or a yarn system that forms a multifilament (26, 28).

5. The touch-and-close fastener part according to claim 4, characterized in that the filaments (10, 12, 16) exhibiting the selected color are provided as the monofilament or form a part of a multifilament (26, 28).

6. The touch-and-close fastener part according to claim 5, characterized in that the weft threads (12) are formed by a monofilament made of a yarn exhibiting the selected color.

7. The touch-and-close fastener part according to claim 5, characterized in that the weft threads (12) are formed by multifilaments of yarns of which at least one exhibits the selected color.

8. The touch-and-close fastener part according to claim 3, characterized in that the pile threads (16) are formed by a multifilament of yarns (26, 28) of varying diameter, of which at least one yarn (26 or 28) exhibits the selected color.

9. The touch-and-close fastener part according to claim 1, characterized in that the pile threads (16) are integrated into the backing part (14) as a V-shaped or W-shaped weave.

10. The touch-and-close fastener part according to claim 2, characterized in that all of the filaments of the warp (10), weft (12), and/or pile threads (16) are formed from filaments having the selected color.
